(19) United States
(12) Patent Application Publication
(10) Pub. No.: US 2019/0236619 A1
(43) Pub. Date: Aug. 1, 2019

(54) TELEMETRIC ANALYTICS USING REGRESSION OVER TIME

(71) Applicant: Microsoft Technology Licensing, LLC., Redmond, WA (US)

(72) Inventor: Christian W. Webber, Redmond, WA (US)

(21) Appl. No.: 15/885,469

(22) Filed: Jan. 31, 2018

(51) Int. Cl. G06Q 30/02

(52) U.S. Cl. CPC G06Q 30/0202; G06F 8/61; G06Q 30/0205

(57) ABSTRACT

Embodiments for determining content using a combination of behavioral data and perceptual data includes receiving an outcome associated with a population. Perceptual data and behavioral data is collected from the population. Changes in the behavioral data are determined. Variables based on the perceptual data, the behavioral data, and the changes in the behavioral data are determined. Each variable is associated with a subset of the population and one variable includes a change in behavioral data and behavioral data. Relationships between the variables and the outcome are determined. Variables are filtered based on the relationships. A regression analysis is run on the filtered variables. Variables are then filtered based on the regression analysis and variables that contribute to the outcome are determined. Content associated with the outcome is targeted to an audience based on content criteria associated with the determined variables.

### BACKGROUND

Explanatory modeling aims to identify factors that are related to an outcome. Currently, most explanatory modeling uses a combination of perceptual variables to explain a perceptual outcome. For example, product satisfaction is explained by a “drivers” model made up of attitudes derived from a survey. This is a traditional approach in market research and political science disciplines that is familiar and proven. In predictive modeling and data science, the latest trend is to focus on behavioral data from telemetry to predict other behavioral outcomes. For example, predicting adoption of a new product or purchase using telemetry data and web clicks. This has historically been the approach to forecasting and is may be used in the web analytics field to predict purchases. As research on understanding human behavior has evolved, one development is that people's perceptions are shaped not just by what they think, but also what they experience. Similarly, human behavior is explained by not just what people do, but what they believe. As this means perceptions like satisfaction are not fully explained by other perceptions captured from surveys, and behavior like purchases is not fully predictable based on behaviors seen in telemetry, both explanatory and predictive modeling are missing key elements.

The challenge in doing drivers modeling research, particularly research combining behavioral or telemetry-based data with survey research, is that the drivers and result (independent and dependent variables) are assumed to be concurrent. This assumption is often not the case, and, therefore, may create issues with cause and effect. To get around this issue, surveys may have an “intent to purchase” question as a future pointing dependent variable and ask people about previous behaviors. Unfortunately, intent to purchase does not guarantee future behavior and stated usage may not reflect actual usage.

In pure behavioral research, a time and sequence element may be applied to predictions and drivers analysis. Attempts, however, to equate behaviors to perceptions, for example usage of something to liking something, are problematic. This may be illustrated by usage of “repair” applications which generally equate to system crashes rather than anything positive.

In cases where survey and telemetry data for the same person may be combined, analysis tends to be a “point in time” as it is unclear where the perception, e.g., “product love”, occurred. The result in knowing that there is a relationship between loving a product and using it, however, may be useful but does not answer which came first: “product love” or product usage. Additionally, the fact that perceptions and behaviors may be on different timelines, and change with different rates, makes driver analysis more difficult when using behaviors from telemetry and perception from survey together. Hence, efforts to use both the behavioral and attitudinal drivers of something is a bit of an “apples to oranges” effort that often confuses cause and effect.

An additional issue with drivers analysis, especially looking at behavioral variables, is that traditional regression which uses easily understandable statistical models predicting and explaining outputs are taxed with a large number of variables which can be interdependent. Choosing which variables to keep that make the best model to both explain and predict outcomes is challenging. Bayesian network techniques, as an alternative, provide easily understood maps of dependencies, but do not provide outputs as easily understood as drivers models.

### BRIEF DESCRIPTION OF THE DRAWINGS

FIG. 1 is a system diagram for combining behavioral data and perceptual data in accordance with respective examples.

FIG. 2 is a flow diagram of a process for combining behavioral data and perceptual data in accordance with respective examples.

FIG. 3 is an example computing device that can be used in conjunction with the technologies described herein.

### DETAILED DESCRIPTION

Analyzing behavioral data and perceptual data separately from one another may miss useful insights. Behavioral data reflects actual observation or detection of what someone does. Examples include telemetry that detects what devices are deployed, what software is installed over time, and usage of devices and software. Data that allocates an observable and measurable number related to a behavior may be included in behavioral data. Perceptual data reflects what a person believes, including what she or he believe they have done, feelings about a product or brand, or attitudes towards technology. Examples include satisfaction, how someone “rates” a brand, or what technology people believe is important. Surveys are one way perceptual data may be collected.

Combining perceptual data and behavioral data in a useful way for explanatory modeling is not as simple as combining two data sets. As described above, combining behavioral data and perceptual data may conflate cause and effect. Without an accurate timeline of the data, a cause-and-effect relationship may be inaccurate or simply wrong. Hence there is a need for a methodology that separates cause from effect sequentially, and takes advantage of both behavioral data and perceptual data over a time period to derive a drivers model. Accordingly, the disclosed embodiments determine a cause-and-effect based on longitudinal data to determine drivers of a particular outcome.

The identified drivers may then be used to update an installation package of a software product to include additional software whose installation is shown to be a driver of installing the additional software. For example, the disclosed embodiments may be used to explain why companies install a software product. For example, a company that uses one software application more than another application may be more likely to install the software application in question. In addition, the company may have various perceptual data that may also drive the software application in question to be installed within the company. To understand the outcome of installing the software product, the behavioral data and perceptual data are combined to predict if a company will install or not install the software product. Behavioral data may include the software installed within the company, what software is used, the number of computers used, etc. Perceptual data that may be used includes how users see the brand of the software product, how the users perceive the benefit of the software, etc.

The disclosed embodiments combine the behavioral data and the perceptual data to explain and then predict if the software will be installed by the companies. Such explanations/predictions or the drivers of those cannot be discovered without analyzing both perceptual data and behavioral data. In addition, this data needs to be collected over a period of time to capture the changes such that an accurate cause and effect relationship may be determined. Without collecting the data over a period of time, determining the cause and effect relationship and accurately identifying drivers would not be possible. In an example, a company that uses a first software product is more inclined to use a second software product. The disclosed embodiments are able to determine that use of the first software drives the use of a second software product. The installation package for the first software package may be modified to ask if a user would like to install the second software product. In an example, this updated installation package is only provided to users that are consistent with the identified drivers, e.g., are part of an organization that uses the first software product. The installation package of a software application, therefore, may be changed to be more efficient in installing software applications.

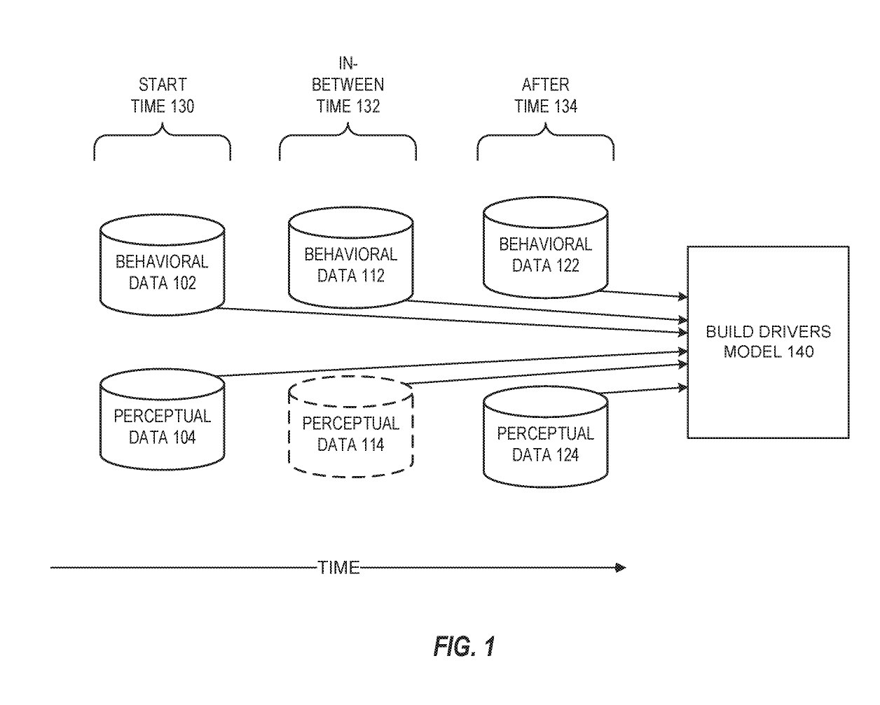

The disclosed embodiments use a longitudinal approach to measure changes in perceptions and behavior and build a drivers model regressing and networking multiple behavioral and perceptual variables that are transformed into independent, salient, numerical data FIG. 1 is a system diagram for combining behavioral data and perceptual data in accordance with respective examples. Prior to collecting data, a behavioral or perceptual change or outcome is received. The disclosed embodiments will determine the drivers of this change/outcome. In addition, a timeframe over which to collect data is received. The timeframe should be long enough to cover the outcome/change. For example, the change may be a perceptual or behavior change. As some non-limiting examples, the change may be a user installing a software application, using a software application for a period of time, posting a comment on social media, or a user changing a perception of a software application or company. The time period may change based on the received outcome/change. The time period may be a week, a month, six months, a year, etc. In an example, data is collected over a month and then may be compared to data collected a month later. This is different than the standard “point in time” approach where both perceptual and behavioral data is collected over one short period of time, e.g., one day. The data collected may also be influenced by the seasonality/differences in data collected over a period of days. For example, data collected on work days from a user may be different from data collected from the same user on non-work days.

In addition, the sources of data may be received. The sources of data may be determined based on the sample and population that is to be measured. The sources of data may include a population of users. For example, the users may be employees of a company or a group of users that use a particular software application. The sample of the users may be determined based on the size of the total population of users.

Next, the behavioral and perceptual data is collected for a start time 130. In an example, a set of behavioral data 102 and a set of perceptual (attitudinal) data 104 are determined and collected. The data may include any data that may be a driver of the desired output/change. In an example, the data is associated with a specific user or organization. Behavioral data may be collected using telemetry and automatically collecting data associated with a user or organization. Behavioral data may include data such as advertising spending, advertising metrics, number of sales visits, support incidents, spend, attendance at marketing events, visits to websites, purchases, etc. Perceptual data may be collected via a survey. In some examples, perceptual data may include social data and self-categorization of activities. For example, social data posts may be analyzed to determine a sentiment of the user. The sentiment may then be used as perceptual data associated with the user. Behavioral data 112 is continued to be collected during an in-between time 132. In some example, perceptual data 114 may also be collected during the in-between time 132. In other examples, the perceptual data 114 is not collected. At the end of the determined time period 134, behavioral data 112 and perceptual data 124 are collected.

There is some overlap between the behavioral data 102, 112, and 122 and the perceptual data 104 and 124. For example, data from the same user or same geographic area is collected. Accordingly, the data 102, 112, 122, 104, and 124 may then be bucketed/grouped together based for the user/organization. The grouping may be based on some identifier associated with the data. In addition, data may be grouped based on geography, business segment, industry, and/or time period.

The behavioral data 102, 112, and 122 may be used to determine behavioral change variables. For periodic scan telemetry, the behavioral data 102, 112, and 122 may be organized by a time period, e.g., a week, a month, etc. The behavioral data 102, 112, and 122 may then be translated into a beginning state and an end state. The beginning state and end state may then be used to create a behavioral change variable that measures the change from the beginning state to the end state. The behavioral data 102, 112, and 122 may be collected continuously over the desired time period. In this example, the behavioral data 102, 112, and 122 may be grouped into time periods. For example, the time periods may correspond to the before time 130, the in-between time 132, and the after time 134. Additionally, the continuously collected behavioral data may be sampled at the beginning and end to determine the beginning and ending values.

Accordingly, in some examples, some behavioral data is not used to calculate differences in behavioral variables. The data that is not used to calculate the differences in behavioral variables may be used to generate interim behavioral variables. For example, if a difference behavioral variable shows that an organization used a particular feature more at the end time, an interim behavioral variable may be used to describe how quickly the change occurred. In this example, the interim behavioral variable may indicate at what point did the organization's use of the feature first surpass a particular threshold. This allows additional possible drivers that would not be available with perceptual data alone or behavioral data collected in one point in time.

After collecting and organizing the data as described above, the data may be processed for analysis. The data may be transformed by removing bias, increasing independence, reducing duplication, allowing for numeric and meaningful measurement, and connecting perceptions and behavioral data that could drive the outcome or change. As described above, behavioral data is collected over a time period. This allows new behavioral variables that include both a “beginning state” point of time data and create “change over time” data by measuring deltas between the beginning and end periods. For example, a person who uses an application for one hour per month in the beginning time and thirty minutes at the end time would have two variables related to the application usage: one hour per month initial usage, and a reduction of thirty minutes or 50% over time. The behavioral data and the perceptual data may then be organized in drivers. Drivers here may be considered independent X variables that influence the desired outcome/change, which is the dependent Y variable.

Some variable data may not be in a usable format. For example, the data may not be in a numerical format. In some examples, the data may be converted to a binary value based on the original value. In other examples, ranges of values over a time period may be converted into a number. For example, the median, mean, etc. of the values may be used for the variable's value for that time period.

The organized data may then be analyzed to determine the relationships between the drivers and the outcome/change that is being analyzed. For example, the data may be analyzed to for interdependencies and relationships, cause and effect, missing or non-meaningful variables, statistical significance, variability and distribution, time sequence, and business and logical relationships. Statistics from regression, correlation, Granger, and other statistical outputs, may also be collected. The relationships and statistics may then be used to understand the independent variables and select the independent variables used to build a drives model.

Returning to FIG. 1, a drivers model 140 is built using the collected data and the selected variables. In an example, a process combining a Bayesian network analysis and multi-variable regression are used together to assess relationships between independent variables. The Bayesian network analysis identifies independent variables that directly or indirectly drive the selected output/change. An independent variable may indirectly drive the selected output/change by influencing another independent variable that does directly drive the selected output/change.

The Bayesian network analysis may also identify independent variables that are highly correlated with one another. The independent variable that has the lesser impact on the dependent variable or the one independent variable driver more by the other highly correlated variable may be identified for removal. The process may include setting a threshold for the direction and amount of relationship between independent and dependent variables that is desirable. For example, the ratio of entropy to the dependent variable divided by the entropy from the sum of each independent variable could be used. Independent variables are selected for removal based on their score in this system. Removing independent variables may reduce the amount of memory and/or processing power needed for subsequent stages of the analysis, e.g., additional Bayesian network and Regression analysis.

After identifying some of the independent variables in the Bayesian network analysis, a Regression of independent variables against the same dependent variable is run. In an example, the regression analysis is done using multiple variable regressions to assess how different variables work together independently. The regressions will identify independent variables that are statistically significant to the desired outcome. Independent variables may be “scored” based on their statistical significance and coefficients. As an example, the independent variables may be scored as the coefficient multiplied by the delta between the minimum and the maximin of the range of the variable times 1 minus the P-value. Independent variables that are not statistically significant, and have inferior “scores” based on the process which combines Bayesian network “score” and the Regression “score” may be removed in order from the worst score. In an example, the scores may be on a 0-100% score and the scores may be summed to create the score that is used to determine if an independent variable is statistically significant.

In an example, the remaining independent variables may then be rerun through a Bayesian network analysis and a Regression as described above, restored, and the process of removing variables that have inferior scores repeated until all variables are statistically significant in the Regression. These remaining variables may then be identified as the independent variables that drove the selected output/change and their impact can be quantified in the output model.

After the analysis is done, independent variables that drive the selected output/change are identified. These independent variables may be paired with other information such as statistical findings, known relationships based on other data, contextually relevant research, and business needs. All of this information may be used to assemble a story that explains why the independent variables drive the selected output/change. The statistical findings from the model may be used to support and provided evidence for the story.

In addition, alternative outcomes, using alternative methodologies or determining if triangulation points are present, may be done to further support the identified independent variables.

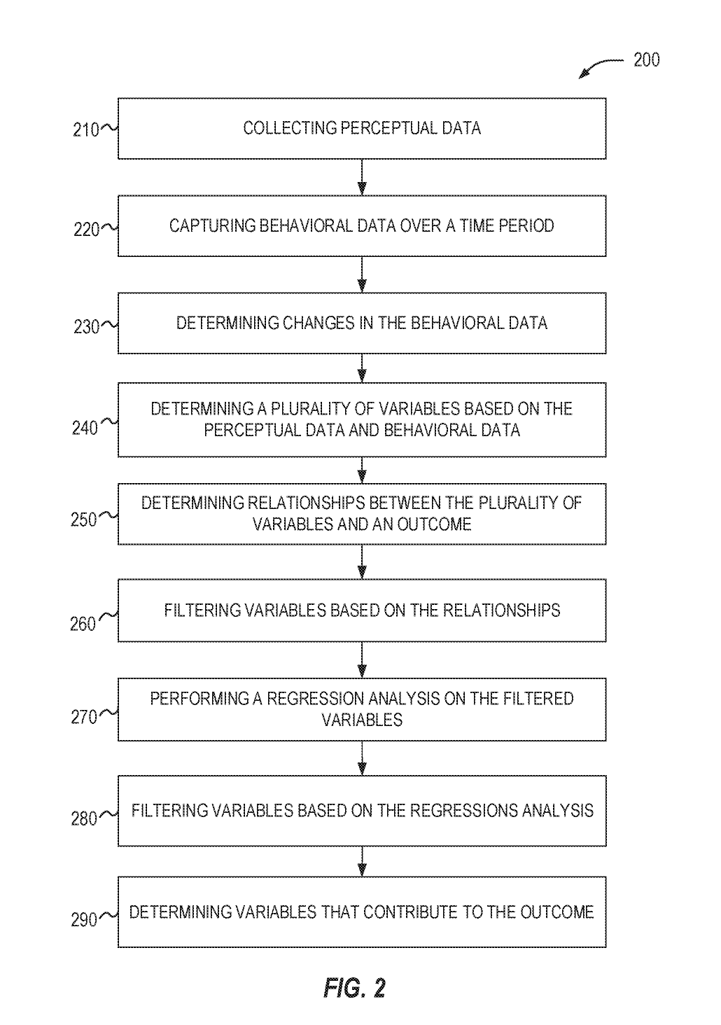

FIG. 2 is a flow diagram of a process for combining behavioral data and perceptual data in accordance with respective examples. To start, an objective to analyze is received. The objective may be analyzing adoption of a software application across a company. Other objectives may include purchasing software, using software, posting on social media, etc. The objective may be received after the perceptual data and behavioral data, which are described below, are collected. At 210, perceptual data is collected. Perceptual data may be collected using surveys or through analysis of postings such as reviews. For example, reviews from a user may be analyzed to determine a sentiment of the user for the reviewed product/service. The sentiment may be used as the perceptual data. The perceptual data is collected at an initial point in time and, therefore, provides an initial perceptual data set. At 220, behavioral data is collected over a time period. Behavioral data may be collected using telemetry to detect how a user interacts with various components, such as hardware, software, applications, devices, etc. The behavioral data is based on actual observations of a user. The time period may be based on the objective. For example, if the objective is software adoption, the time period is selected to be long enough to cover a reasonable amount of time to allow users to adopt the software. In this example, the time period would be longer than a short period, e.g., a day, a week, etc. Instead, the time period is long enough to allow users to adopt the software, e.g., a month, six months, a year.

At 230, changes in the behavioral data are determined. Changes may be based on behavioral data from an initial portion of the behavioral data and an ending portion of the behavioral data. For example, the first half, first third, etc. of the time period may be used as the initial portion with the second half or last third as the ending period. In an example, ending perceptual data may also be captured. Changes in the perceptual data may be determined using the initial perceptual data and the ending perceptual data.

At 240, a plurality of variables is determined based on the perceptual data, the behavioral data, and the changes in the behavioral data. Variables may be any data points that may be derived from the data. For example, survey questions may each be a variable. In addition, each behavioral data point along with changes in the behavioral data point may each be a variable,

At 250, relationships between the variables are determined. For example, a Bayesian network analysis may be done to assess the relationship between the variables. At 260, variables that are not related to the outcome may be identified and filtered from the output using the entropy ratios between independent and dependent variables from the output. Also, the variables that are more driven by other variables than they are drivers of the outcome may be removed from the variables. In addition, if multiple variables are highly correlated with one another, all but one variable may be removed to reduce the number of variables. The variables removed may be the variables that have the least impact on the outcome. Note that the process may sequence the removal of variables based on each Bayesian network run so that independent variables that are clearly not drivers of the dependent variable are removed entirely at this point. Alternatively, the “scores” of variables may be kept so that variables are removed to allow the algorithm to leverage the combination of Regression and Bayesian network outputs.

At 270, a regression analysis is run using the same or the remaining variables. For example, a multivariate linear regressions analysis may be run to identify how statistically significant a variable is to the outcome. At 280, the variables that are least statistically significant, or in the case of a combination Bayesian network plus Regression “scored” algorithm those with the worst overall scores, are removed from the variables. For example, all but the top 3, 5, 10, etc. variables may be removed. At 290, the variables that contribute to outcome are determined and their impact is quantified. An additional Bayesian network analysis may be run on the remaining variables to determine the relationship between variables that contribute to the outcome. Using a combination of perceptual, behavioral, and changes in the behavioral data over a time period allows for new insights to be determines that would have been missed using perceptual data, behavioral data, or a combination of these.

An example use of the described examples is determining how to place an advertisement to help achieve an outcome. For example, if the outcome is to drive adoption of a software product, drivers of the software product adoption may be used to determine how advertisements are targeted and the content of those advertisements. In this example, perceptual data of people within an organization such as: general impression of a software maker; intention to purchase new software; impression that the software maker is a leader; impression of the software product quality; etc., may be collected. Behavioral data from the organization may also be collected. The behavioral data may include: the organization's use of another software product; number of social media posts that mention the software product; the organization's adoption of another software product; employee count of the organization; revenue of the organization; organization's segment or field; etc. The behavioral data may be used to generate additional variables that are based on changes in behavioral data over time. For example, an organization's change in use of servers; chain in use of another software product; change in number of server's deployed; change in social media posts regarding the software product or another software product; etc.

The perceptual data, behavioral data, and changes in the behavioral data may be analyzed to create a variable set. The variable set may be a set of variables that correspond to content criteria. For example, an advertising placement service may also advertisements to be targeted using various content criteria. The content criteria may be used to define a variable set. As an example, the content criteria may include the ability to target advertisements based on: use of a software product; a user's organization; an organization's adoption of a software product; a change in software product installs within an organization; etc. These content criteria may be used to create a variable set that has one variable that corresponds to each of the content criteria.

The perceptual data, behavioral data and the changes in behavioral data may be analyzed to determine values for the variables. The data may be collected such that individuals are not identifiable. A Bayesian network analysis with the variables and their values as input may be performed to identify variables that drive the selected output/change. Variables that do not influence or have the leave impact on the selected output/change may be removed from the data set. In an example, the variables may also be used as part of a regression analysis to determines variables that have a statistically significant impact on the selected output/change. The variables that have the least impact on the change/output may be filtered. The Bayesian network analysis and the regression analysis may be performed concurrently using the same variables. The overlap between the unfiltered variables may be used as the variable set that drives the selected output/change. In another example, the Bayesian network analysis or regression analysis may be performed first. In this example, the filtered variables may be used as input in the second analysis.

Continuing the software adoption example, the Bayesian network analysis and regression analysis may identify that there are variables that both drive and negatively drive the outcome. For example, organizations that have increased deployments of another software product, organizations within the public sector, and organizations with an increase in social media posts regarding a topic may be identified as statistically significant driving factors in the organization adoption the software product. Based on these variables, an advertisement for the software product may be targeted to users that match the three variables.

As another example, a driving variable may be an organization's use of another software product. In this example, an advertisement for the software product may be targeted to users within an organization that use and whose use has increased of another software product. Advertising budgets, therefore, may be spent on targeting users that are more likely to be driven to adopt the software product. Using the determined variables, advertising budgets may be spent more efficiently to drive the desired outcome/change.

In addition, the variables that negatively drive the output may also be targeted. The targeting of these users, however, may be different. For example, rather than targeting an advertisement to adopt the software product, the advertisement may include content that touts the features of the software product. As an example, a negative variable may be an organization's decrease in using another software product, or a positive change in perception of a competing software product. In this example, an advertisement that highlights the benefits of using the software product over the competing software product may be targeted to the users that have had a positive change in perception of the competing software product.

The disclosed embodiments, may also be used to determine a companion software product to install when a user installs a software product. For example, an analysis of data across various organizations may show that a driver of using the software product is if an organization also uses a second software product and use mobile devices frequently during the work day. Another driver may be the organizations perception of the developer of the second software product. Based on this finding, an install package for the second software product may include an option to install the software product. The updated install package may then be sent to organization that have data that correspond with some or all of the identified drivers, e.g., have a positive perception of the developer of the second software product and use mobile devices during workdays.

The install package may include a request to a server to ask if there are any companion software products that should be presented to the user. In this example, the server would respond with information regarding the software product. The install process may then allow the user to select to install the software product. Without the described analysis of behavioral and perceptual data, the install process would either not provide an option to install the software product or always provide the option. Neither of these is ideal. Using the described embodiments to determine if and what companion software product to include allows users to be presented with relevant companion software products.

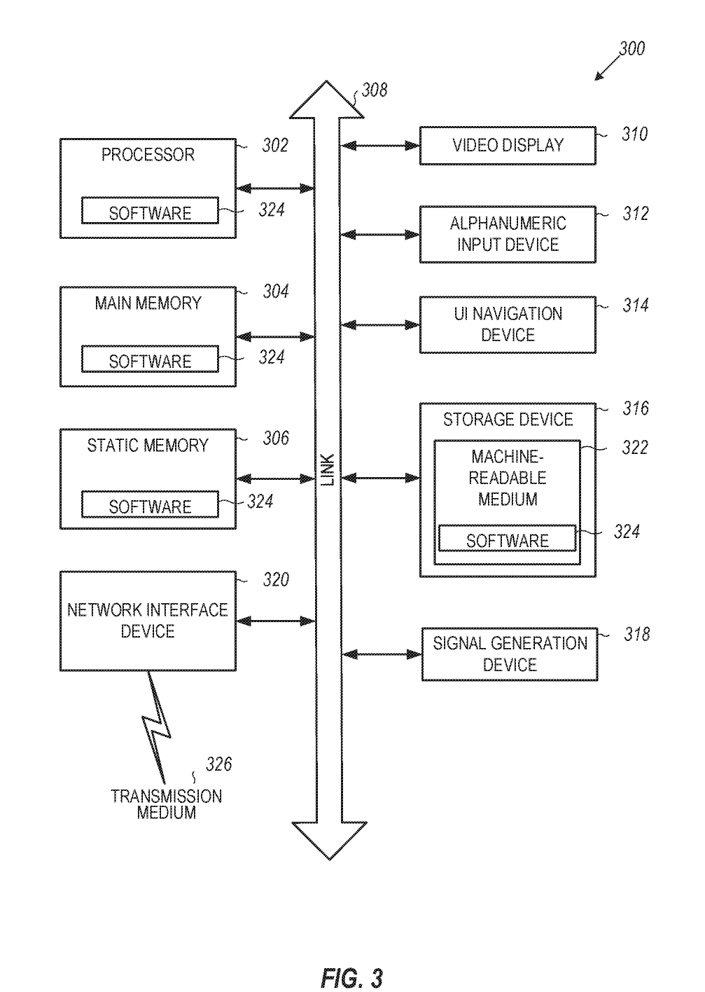

FIG. 3 is an example computing device that can be used in conjunction with the technologies described herein. In alternative embodiments, the computing device 300 may operate as a standalone device or may be connected (e.g., networked) to other computing devices. In a networked deployment, the computing device 300 may operate in the capacity of a server communication device, a client communication device, or both in server-client network environments. In an example, the computing device 300 may act as a peer computing device in peer-to-peer (P2P) (or other distributed) network environment. The computing device 300 may be a personal computer (PC), a tablet PC, a set top box (STB), a personal digital assistant (PDA), a mobile telephone, a smart phone, a web appliance, a network router, switch or bridge, or any computing device capable of executing instructions (sequential or otherwise) that specify actions to be taken by that computing device. Further, while only a single computing device is illustrated, the term “computing device” shall also be taken to include any collection of computing devices that individually or jointly execute a set (or multiple sets) of instructions to perform any one or more of the methodologies discussed herein, such as cloud computing, software as a service (SaaS), other computer duster configurations. Computing device may be an implementation of device 110, 120, 130, and may implement the profile store 140, and perform the method of FIG. 2.

Computing device 300 may include a hardware processor 302 (e.g., a central processing unit (CPU), a graphics processing unit (GPU), a hardware processor core, or any combination thereof), a main memory 304 and a static memory 306, some or all of which may communicate with each other via a link (e.g., bus) 308. The computing device 300 may further include a display unit 310, an input device 312 (e.g., a keyboard), and a user interface (UI) navigation device 314 (e.g., a mouse). In an example, the display unit 310, input device 312, and UI navigation device 314 may be a touch screen display. In an example, the input device 312 may include a touchscreen, a microphone, a camera (e.g., a panoramic or high-resolution camera), physical keyboard, trackball, or other input devices.

The computing device 300 may additionally include a storage device (e.g., drive unit) 316, a signal generation device 318 (e.g., a speaker, a projection device, or any other type of information output device), a network interface device 320, and one or more sensors 321, such as a global positioning system (GPS) sensor, compass, accelerometer, motion detector, or other sensor. The computing device 300 may include an input/output controller 328, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.) via one or more input/output ports.

The storage device 316 may include a computing-readable (or machine-readable) storage media 322, on which is stored one or more sets of data structures or instructions 324 (e.g., software) embodying or utilized by any one or more of the techniques or functions described herein. In an example, at least a portion of the software may include an operating system and/or one or more applications (or apps) implementing one or more of the functionalities described herein. The instructions 324 may also reside, completely or at least partially, within the main memory 304, within the static memory 306, and/or within the hardware processor 302 during execution thereof by the computing device 300. In an example, one or any combination of the hardware processor 302, the main memory 304, the static memory 306, or the storage device 316 may constitute computing device (or machine) readable media.

While the computer-readable storage media 322 is illustrated as a single medium, a “computer-readable storage media” or “machine-readable storage media” may include a single medium or multiple media e.g., a centralized or distributed database, and/or associated caches and servers) configured to store the one or more instructions 324.

In an example, a computer-readable storage media or machine-readable storage media may include any medium that is capable of storing, encoding, or carrying instructions for execution by the computing device 300 and that cause the computing device 300 to perform any one or more of the techniques of the present disclosure, or that is capable of storing, encoding or carrying data structures used by or associated with such instructions. Non-limiting computer-readable storage media examples may include solid-state memories, and optical and magnetic media. Specific examples of computer-readable storage media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and optical media disks. The computer-readable storage media is non-transitory in that the storage media does not consist of transitory propagating signals.

The instructions 324 may further be transmitted or received over a communications network 326 using a transmission medium via the network interface device 320 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.3 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. The network interface device 320 may use the transfer protocols to transmit data using transitory propagating signals.

In an example, the network interface device 320 may include one or more physical jacks (e.g., Ethernet, coaxial, or phone jacks) or one or more antennas to connect to the communications network 326. In an example, the network interface device 320 may include one or more wireless modems, such as a Bluetooth modem, a Wi-Fi modem or one or more modems or transceivers operating under any of the communication standards mentioned herein. In an example, the network interface device 320 may include a plurality of antennas to wirelessly communicate using at least one of single-input multiple-output (SIMO), multiple-input multiple-output (MIMO), or multiple-input single-output (MISO) techniques. In some examples, the network interface device 320 may wirelessly communicate using Multiple User MIMO techniques. In an example, a transmission medium may include any intangible medium that is capable of storing, encoding or carrying instructions for execution by the computing device 300, and includes digital or analog communications signals or like communication media to facilitate communication of such software.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

The above description is intended to be illustrative, and not restrictive. For example, the above-described examples (or one or more aspects thereof) may be used in combination with others. Other embodiments may be used, such as by one of ordinary skill in the art upon reviewing the above description. Further, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A method for selecting content using a combination of behavioral data and perceptual data, the method comprising operations performed using an electronic processor, the operations comprising:
receiving an objective outcome associated with a population;
collecting initial perceptual data from the population collected over an initial time period, wherein the perceptual data is associated with content criteria;
capturing behavioral data from the population over a time period after the initial time period, wherein the behavioral data is associated with the content criteria;
determining changes in the behavioral data of members in the population;
determining a plurality of variables based on the initial perceptual data, the behavioral data, and the changes in the behavioral data, wherein each variable is associated with a subset of the population, wherein a first variable comprises a first change in behavioral data and first behavioral data, and wherein the plurality of variables are associated with the content criteria;
determining relationships between the plurality of variables and the objective outcome;
filtering variables from the plurality of variables based on the determined relationships to create a filtered plurality of variables;
running a regression analysis on the filtered plurality of variables;
filtering variables from the filtered plurality of variables based on the regression analysis;
determining variables from the remaining plurality of variables that contribute to the objective outcome, wherein the remaining plurality of variables comprise the first variable;
targeting content associated with the objective outcome to an audience based on the content criteria associated with the determined variables.

2. The method of claim 1, wherein the first behavioral data comprises an initial application usage time and the first change in behavioral data comprises a change in the initial application usage time.

3. The method of claim 1, further comprising receiving the time period over which to collect the behavioral data.

4. The method of claim 1, wherein a second variable comprises a second change in behavioral data and perceptual data, and wherein the remaining plurality of variables comprise the second variable.

5. The method of claim 1, wherein the determining relationships comprises running a Bayesian network analysis.

6. The method of claim 1, wherein the determining changes in the behavioral data comprises:
determining an initial behavioral time period;
calculating, for each behavioral variable, an initial value based on the behavioral data within the initial behavioral time period;
determining an ending behavioral time period; and
calculating, for each behavioral variable, an ending value based on the behavioral data within the ending behavioral time period, wherein the change in the behavioral data is a difference between the ending value and the initial value.

7. The method of claim 1, wherein each variable is associated with a subset of the population based on geography.

8. The method of claim 1, further comprising:
collecting ending perceptual data from the population collected over an ending time period; and
determining changes in perceptual data of members in the population based on the initial perceptual data and the ending perceptual data, wherein the plurality of variables comprise a variable based on the changes in perceptual data.

9. The method of claim 8, wherein the remaining plurality of variables comprise the variable based on the changes in perceptual data.

10. The method of claim 1, further comprising determining the content based on the determined variables.

11. The method of claim 1, wherein the determined variables comprise demographic variables.

12. A system for determining content using a combination of behavioral data and perceptual data, the system comprising:
an electronic processor configured to:
receive an objective outcome associated with a population;
collect initial perceptual data from the population collected over an initial time period, wherein the perceptual data is associated with content criteria;
capture behavioral data from the population over a time period after the initial time period, wherein the behavioral data is associated with the content criteria;
determine changes in the behavioral data of members in the population;
determine a plurality of variables based on the initial perceptual data, the behavioral data, and the changes in the behavioral data, wherein each variable is associated with a subset of the population, wherein a first variable comprises a first change in behavioral data and first behavioral data, and wherein the plurality of variables are associated with the content criteria;
determine relationships between the plurality of variables and the objective outcome;
filter variables from the plurality of variables based on the determined relationships;
run a regression analysis on the filtered plurality of variables;
filter variables from the plurality of variables based on the regression analysis;
determine variables from the remaining plurality of variables that contribute to the objective outcome, wherein the remaining plurality of variables comprise the first variable;
target content associated with the objective outcome to an audience based on the content criteria associated with the determined variables.

13. The system of claim 10, wherein a second variable comprises a second change in behavioral data and perceptual data, and wherein the remaining plurality of variables comprise the second variable.

14. The system of claim 10, wherein to determine relationships the electronic processor is configured to run a Bayesian network analysis.

15. The system of claim 1, wherein to determine changes in the behavioral data the electronic processor is configured to:
determine an initial behavioral time period;
calculate, for each behavioral variable, an initial value based on the behavioral data within the initial behavioral time period;
determine an ending behavioral time period; and
calculate, for each behavioral variable, an ending value based on the behavioral data within the ending behavioral time period, wherein the change in the behavioral data is a difference between the ending value and the initial value.

16. The system of claim 10, wherein each variable is associated with a subset of the population based on geography.

17. A computer-readable storage media storing computer-executable instructions for determining content using a combination of behavioral data and perceptual data, the stored instructions comprising:
instructions to receive an objective outcome associated with a population;
instructions to collect initial perceptual data from the population collected over an initial time period, wherein the perceptual data is associated with content criteria;
instructions to capture behavioral data from the population over a time period after the initial time period, wherein the behavioral data is associated with the content criteria;
instructions to determine changes in the behavioral data of members in the population;
instructions to determine a plurality of variables based on the initial perceptual data, the behavioral data, and the changes in the behavioral data, wherein each variable is associated with a subset of the population, wherein a first variable comprises a first change in behavioral data and first behavioral data, and wherein the plurality of variables are associated with the content criteria;
instructions to determine relationships between the plurality of variables and the objective outcome;
instructions to filter variables from the plurality of variables based on the determined relationships;
instructions to run a regression analysis on the filtered plurality of variables;
instructions to filter variables from the plurality of variables based on the regression analysis;
instructions to determine variables from the remaining plurality of variables that contribute to the objective outcome, wherein the remaining plurality of variables comprise the first variable;
instructions to target content associated with the objective outcome to an audience based on the content criteria associated with the determined variables.

18. The computer-readable storage media of claim 17, wherein a second variable comprises a second change in behavioral data and perceptual data, and wherein the remaining plurality of variables comprise the second variable.

19. The computer-readable storage media of claim 17, wherein the instructions to determine relationships comprise instructions to run a Bayesian network analysis.

20. The computer-readable storage media of claim 17, wherein the instructions to determine changes in the behavioral data comprise:
instructions to determine an initial behavioral time period;
instructions to calculate, for each behavioral variable, an initial value based on the behavioral data within the initial behavioral time period;
instructions to determine an ending behavioral time period; and
instructions to calculate, for each behavioral variable, an ending value based on the behavioral data within the ending behavioral time period, wherein the change in the behavioral data is a difference between the ending value and the initial value.
